(19) United States
(12) Patent Application Publication
(10) Pub. No.: US 2017/0167932 A1
(43) Pub. Date: Jun. 15, 2017

(54) INTEGRATED SENSORS FOR STRUCTURAL HEALTH MONITORING

(71) Applicant: The Trustees of the Stevens Institute of Technology, Hoboken, NJ (US)

(72) Inventors: Dimitri Donskoy, Fair Haven, NJ (US); Marcus Rutner, Edgewater, NJ (US)

(73) Assignee: The Trustees of the Stevens Institute of Technology, Hoboken, NJ (US)

(21) Appl. No.: 15/374,412

(22) Filed: Dec. 9, 2016

Related U.S. Application Data
(60) Provisional application No. 62/265,679, filed on Dec. 10, 2015.

(51) Int. Cl. G01L 9/00; G01L 19/08

(52) U.S. Cl. CPC G01L 9/008; G01L 19/086

(57) ABSTRACT

A wireless sensor includes a sensing element, a signal conditioning element, and a passive RFID tag. The sensing element is adapted to provide an electrical response indicating whether a physical parameter applied to the wireless sensor has exceeded a predetermined threshold. The signal conditioning element is electrically coupled to the sensing element and is adapted to detect the electrical response of the sensing element. The passive RFID tag is electrically coupled to the signal conditioning element. The passive RFID tag is adapted to be powered by an interrogation by an RFID reader, to receive an indication of the electrical response from the signal conditioning element, and to transmit the indication to the RFID reader.

### CROSS-REFERENCE TO RELATED APPLICATION

This application is a Section 111(a) application relating to and claiming the benefit of commonly owned, co-pending U.S. Provisional Patent Application No. 62/265,679, titled “INTEGRATED SENSORS FOR STRUCTURAL HEALTH MONITORING,” having a filing date of Dec. 10, 2015, which is incorporated by reference herein in its entirety.

### FIELD OF THE INVENTION

The exemplary embodiments relate generally to sensors that are adapted to be attached to or embedded within a structure to passively monitor the health of the structure.

### BACKGROUND OF THE INVENTION

Existing sensors adapted to be embedded within or attached to a structure to be monitored require energy to perform sensing and to transmit a signal containing sensed data. Such sensors may be wired or wireless. Wired sensors may compromise structural integrity due to the presence of wires embedded in the material and interconnecting the sensors, and may be impractical, due to factors such as potential wire shear-off. Battery-powered wireless sensors have finite life cycles and require periodic replacement of batteries. There is a need for a battery-free sensor that wirelessly detects and transmits information about the condition of a structure that is being monitored by such a sensor.

### SUMMARY OF THE INVENTION

In an embodiment, a wireless sensor includes a sensing element, a signal conditioning element, and a passive RFID tag. The sensing element is adapted to provide an electrical response indicating whether a physical parameter applied to the wireless sensor has exceeded a predetermined threshold. The signal conditioning element is electrically coupled to the sensing element and is adapted to detect the electrical response of the sensing element. The passive RFID tag is electrically coupled to the signal conditioning element. The passive RFID tag is adapted to be powered by an interrogation by an RFID reader, to receive an indication of the electrical response from the signal conditioning element, and to transmit the indication to the RFID reader.

In an embodiment, the wireless sensor is adapted to be fixed at a location of a structure in a manner such that the mechanical load applied to the wireless sensor corresponds to a physical parameter applied to the location of the structure. In an embodiment, the wireless sensor also includes a second sensing element adapted to provide a second electrical response indicating whether the physical parameter applied to the wireless sensor has exceeded a second predetermined threshold.

In an embodiment, the sensing element includes a piezoelectric element and the electrical response is a voltage induced in the piezoelectric element by a deformation of the piezoelectric element. In an embodiment, the wireless sensor includes a hollow spherical body including a wall defining an internal area. The wall has a circular cutout formed therein. The piezoelectric element has a shape of a spherical cap and is sized and shaped so as to be complementary to the circular cutout. The piezoelectric element is disposed within the circular cutout.

In an embodiment, the wireless sensor includes a hollow spherical body defining an internal surface, a locking element formed on the internal surface of the spherical body, and a piezoelectric element that is positioned in a first position such that the locking element engages a first end of the piezoelectric element. The piezoelectric element is biased to a second position such that the first end of the piezoelectric element does not engage the locking element. In an embodiment, the physical parameter is a pressure. The hollow spherical body is sized and shaped so as to deform when the pressure applied to the wireless sensor exceeds the predetermined threshold, whereby the deformation of the hollow spherical body causes the locking element to disengage the first end of the piezoelectric element, thereby allowing the piezoelectric element to move to the second position.

In an embodiment, the piezoelectric element has a columnar shape. In an embodiment, the physical parameter is a force. The columnar piezoelectric element is sized and shaped so as to buckle when the force applied to the wireless sensor exceeds the predetermined threshold. In an embodiment, the piezoelectric element includes a first dielectric layer, a first metal layer adjacent the first dielectric layer, a piezoelectric layer adjacent the first metal layer and opposite the first dielectric layer, a second metal layer adjacent the piezoelectric layer and opposite the first metal layer, and a second dielectric layer adjacent the second metal layer and opposite the piezoelectric layer.

In an embodiment, the physical parameter is a force. The sensing element includes a conducting element that is adapted to crack when the force applied to the wireless sensor exceeds the predetermined threshold. The electrical response is an indication of whether an applied electrical current flows through the conducting element. In an embodiment, the conducting element is adapted to be bonded directly to an object to be monitored by the wireless sensor. In an embodiment, the conducting element, the signal conditioning element, and the passive RFID tag are disposed on a flexible patch. The flexible patch is adapted to be bonded to an object to be monitored by the wireless sensor.

In an embodiment, the physical parameter is a force. The sensing element includes a conducting element having an electrical resistance. The conducting element is adapted to strain when the force applied to the wireless sensor exceeds the predetermined threshold. The straining of the conducting element changes electrical resistance of the conducting element. The electrical response is a voltage across the sensing element when a constant electrical current is applied to the sensing element. In an embodiment, the conducting element, the signal conditioning element, and the passive RFID tag are disposed on a flexible patch. The flexible patch is adapted to be bonded to an object to be monitored by the wireless sensor.

In an embodiment, the physical parameter is an incline. The sensing element includes an inclinometer element having a varying electrical resistance. The inclinometer element is adapted to have a first electrical resistance when the incline is less than the predetermined threshold, and is adapted to have a second electrical resistance when the incline is greater than the predetermined threshold. The second electrical resistance is different than the first electrical resistance. In an embodiment, the electrical response is a voltage across the inclinometer element when a constant electrical current is applied to the inclinometer element.

In an embodiment, a method for detecting damage to a structure includes affixing a wireless sensor to a location of the structure. The wireless sensor includes a sensing element, a signal conditioning element, and a passive radio-frequency identification tag. The method also includes operating a radio-frequency identification reader to interrogate the passive radio-frequency identification tag of the wireless sensor, whereby the radio-frequency identification reader powers the passive radio-frequency identification tag. The method also includes receiving, by the radio-frequency identification reader from the passive radio-frequency identification tag of the wireless sensor, a sensing response of the sensing element. The sensing response indicates a damage state at the location of the structure. In an embodiment, the step of affixing the wireless sensor to the structure includes attaching the wireless sensor to a surface of the structure. In an embodiment, the step of affixing the wireless sensor to the structure includes embedding the wireless sensor within the structure.

In an embodiment, a sensor is integrated into a structure to detect short-term and long-term, slowly evolving events. In an embodiment, a sensor is coupled to passive radio-frequency identification (“RFID”) technology to operate and transmit structural integrity information without internal power and wires. In an embodiment, an RFID reader attached to a vehicle or flying object can scan the surface of the respective structure or component to be monitored. Accordingly, the proposed technology enables large-area monitoring. The approach is applicable for most structural materials, (e.g., metal, concrete, composites, etc.) operating in a wide range of environmental conditions. The proposed technology provides advantages in regard to practicality, accuracy of the measurements and data transmission, and cost-effectiveness of the structure health monitoring approach.

### BRIEF DESCRIPTION OF FIGURES

FIG. 1A shows a first exemplary embodiment of a sensor;

FIG. 1B shows the exemplary sensor of FIG. 1A in a loaded condition;

FIG. 2A shows a second exemplary embodiment of a sensor;

FIG. 2B shows a cross-sectional view of a portion of the exemplary sensor of

FIG. 2A taken along a section line 2B-2B and looking in the direction of the arrows;

FIG. 2C shows the cross-sectional view of FIG. 2B in both an unloaded and a loaded condition;

FIG. 3 shows a plot of pressure that may be applied to the sensor of FIG. 1A or the sensor of FIG. 2A and a corresponding plot of voltage that may recorded by such a sensor;

FIG. 4A shows a third exemplary embodiment of a sensor;

FIG. 4B shows a detailed view of a portion of the exemplary sensor of FIG. 4A;

FIG. 4C shows the exemplary sensor of FIG. 4A in both an unloaded and a loaded condition;

FIG. 5A shows a fourth exemplary embodiment of a sensor;

FIG. 5B shows a fifth exemplary embodiment of a sensor;

FIG. 5C shows a sixth exemplary embodiment of a sensor;

FIG. 5D shows a seventh exemplary embodiment of a sensor;

FIG. 5E shows a photograph of a prototype of the exemplary sensor of FIG. 5C, the prototype being shown in a loaded condition;

FIG. 6A shows a schematic illustration of an eighth exemplary embodiment of a sensor;

FIG. 6B a schematic illustration of a structure instrumented with multiple instances of the sensor of FIG. 6A; and

FIG. 6C shows the structure of FIG. 6B in a loaded condition.

### DETAILED DESCRIPTION OF THE DRAWINGS

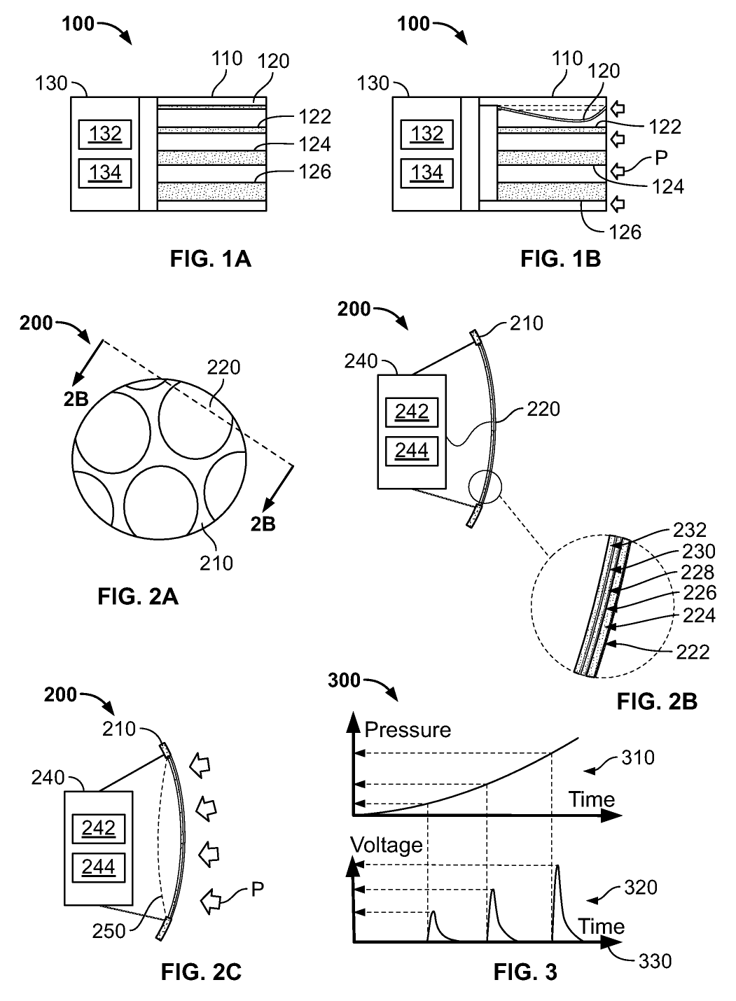

FIG. 1A illustrates a first embodiment of a sensor 100. The sensor 100 of FIG. 1A is adapted to perform one-dimensional sensing. The sensor 100 of FIG. 1A may be implemented in a microelectromechanical system (“MEMS”). FIG. 1A illustrates an exemplary sensor 100 including several piezoelectric columns 120, 122, 124, 126 mounted on a base with an embedded microchip 130, and surrounded by an encasement 110. The piezoelectric columns 120, 122, 124, 126 may have varying diameters, such that they fail in a buckling mode when pre-defined pressure thresholds are reached. The microchip 130 may include an integrated signal conditioning element 132 and a passive RFID tag 134. The signal conditioning element 132 may be operative to act as a voltmeter capable of measuring voltage generated by the piezoelectric columns 120, 122, 124, 126, as will be discussed hereinafter.

FIG. 1B illustrates the sensor 100 of FIG. 1A in a loaded condition. An external pressure P puts a load on the encasement 110, which compresses the piezoelectric columns 120, 122, 124, 126. Compression of the piezoelectric columns 120, 122, 124, 126 generates a voltage burst, which is received by the signal conditioning element 132. Because the piezoelectric columns 120, 122, 124, 126 have different diameters, they may show unstable behavior at different pressure levels. The voltage bursts generated by the weakest column (i.e., in the embodiment shown in FIGS. 1A and 1B, the column 120) to the strongest column (i.e., in the embodiment shown in FIGS. 1A and 1B, the column 126) may mark a short-term event when failing simultaneously, or a long-term, slowly developing event, when becoming unstable one after the other with time periods in between. FIG. 1B illustrates the sensor of FIG. 1A after exposure to a load that is sufficient to cause only the column 120, which is the thinnest (i.e., weakest) of the piezoelectric columns 120, 122, 124, 126, to buckle. For comparison, the original (i.e., not buckled) position of the column 120 is shown in dashed lines in FIG. 1B.

FIGS. 2A-2C illustrate a second embodiment of a sensor 200. The sensor 200 of FIGS. 2A-2C may include a sensing sphere 210, which may be fabricated by a process that includes micro-machining. In an embodiment, the sensing sphere 210 is made from metal. In an embodiment, the sensing sphere 210 is made from plastic. As shown in FIG. 2A, the sensing sphere 210 has multiple circular cut-outs 220. For clarity, only one of the cut-outs 220 is indicated in FIG. 2A, but the reference numeral 220 refers to all of the cut-outs shown in FIG. 2A, as well as cut-outs located on the reverse side of the sensing sphere 210 and not visible in FIG. 2A.

FIG. 2B shows a cross-sectional view of the sensor 200 along section line 2B-2B of FIG. 2A. As shown in FIG. 2B, each cut-out 220 may be filled with a corresponding one of a plurality of piezoelectric shells 228 made of a piezoelectric material and having a size and shape complementary to the corresponding one of the cut-outs 220, each of which may be coated with dielectric coatings 226, 230 on both sides. The shape of each of the piezoelectric shells 228 may be referred to as a spherical cap. The combination of each piezoelectric shell 228 and its corresponding dielectric coatings 226, 230 may be shielded by pre-stressed metal sheets 224, 232 on both sides. A protective polymer coating 222 may be applied to each pre-stressed metal sheet 224 that is positioned to the exterior of the sensing sphere 210. The sensor 200 also includes a microchip 240, which is coupled to each of the piezoelectric shells 228 of the sensor 200. The microchip 240 includes an integrated signal conditioning element 242 and a passive RFID tag 244. The signal conditioning element 242 may be operative to act as a voltmeter capable of measuring voltage generated by the piezoelectric shells 228, as will be discussed hereinafter. A build-up of external pressure may trigger a snapping-through effect of one or more of the piezoelectric shells 228. Each of the piezoelectric shells 228 of the exemplary sensor 200 may be tuned to snap through at a different pressure threshold. For example, the metal sheets 224, 232 surrounding each of the piezoelectric shells 228 may be pre-stressed to a different level such that each piezoelectric shell 228 will snap through at a different predetermined pressure threshold.

FIG. 2C shows the cross-sectional view of FIG. 2B, showing an exemplary piezoelectric shell 228 both before and after being snapped through by an external pressure P. The position of the piezoelectric shell 228 after being snapped through is indicated by reference numeral 250. The snapping-through effect of one of the piezoelectric shells 228 of the sensor 200 of FIGS. 2A-2C generates a burst of electric voltage, which is received by the signal conditioning element 242 and saved in a memory of the RFID tag 244.

The sensor 100 of FIGS. 1A and 1B and the sensor 200 of FIGS. 2A-2C allow the monitoring of the evolution of structural loads over time. The sensor 100 of FIGS. 1A and 1B allows the monitoring of the evolution of a linear stress over time. The sensor 200 of FIGS. 2A-2C allows the monitoring of the evolution and buildup of a pressure over time. For example, the sensor 200 of FIGS. 2A-2C may be suitable for measurement of direct corrosion-induced pressure buildup in reinforced concrete structures. FIG. 3 shows a graph 300 indicating measurements that may be recorded by the sensor 200. In particular, the graph 300 includes a plot 310 showing buildup of external pressure and a plot 320 showing the corresponding bursts of electric charge induced by the snapping of piezoelectric elements 228 within the exemplary sensor 200. Both the plot 310 and the plot 320 are shown against a consistent time axis 330.

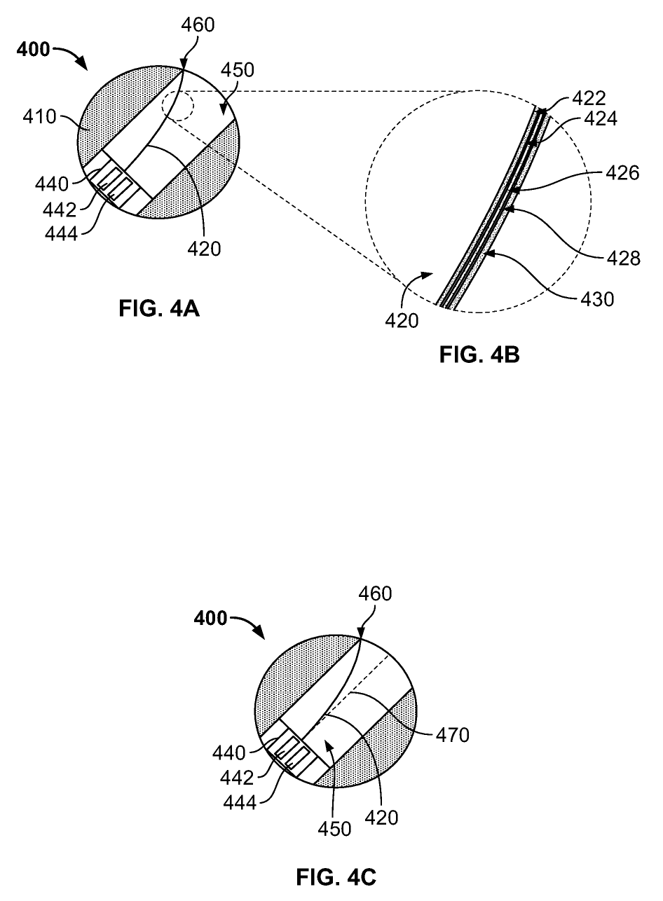

FIGS. 4A-4C illustrate a third exemplary embodiment of a sensor 400. The sensor 400 of FIGS. 4A-4C may include a sensing sphere 410, which may be fabricated by a process that includes micro-machining. The sensing sphere 410 of FIG. 4A includes an installed piezoelectric cantilever 420. FIG. 4B illustrates a detailed view of a portion of the sensor 400 of FIG. 4A. As shown in FIG. 4B, the piezoelectric cantilever 420 includes a piezoelectric layer 426 with dielectric coatings 424, 428 to either side thereof. A pre-stressed metal layer 422, 430 is disposed to the side of each of the dielectric coatings 424, 428 opposite the piezoelectric layer 426. In an embodiment, the piezoelectric cantilever 420 may be coupled to a microchip 440. The microchip 440 includes an integrated signal conditioning element 442 and a passive RFID tag 444. The signal conditioning element 442 may be operative to act as a voltmeter capable of measuring voltage generated by the piezoelectric layer 426 of the piezoelectric cantilever 420, as will be discussed hereinafter. The piezoelectric cantilever 420 may be fixed in an air-filled space 450 within the sensing sphere 410. Prior to installation, one end of the piezoelectric cantilever 420 may be bent into a first, locked position and secured in the locked position by a lock 460. This position causes a stress state in the piezoelectric cantilever 420. The lock 460 may be adapted to respond to external pressure by unlocking mechanically when a pressure applied to the sensing sphere 410 reaches a pre-defined pressure threshold. This may be accomplished by sizing and configuring the sensing sphere 410 such that it deforms at a pre-defined pressure threshold, thereby releasing the lock 460 from the piezoelectric cantilever 420 and allowing the piezoelectric cantilever 420 to return to a second, unstressed position.

FIG. 4C shows the sensor 400 of FIG. 4A, showing a comparison of the position of the piezoelectric cantilever 420 both before and after the lock 460 has unlocked. The original position of the piezoelectric cantilever continues to be shown using the reference numeral 420, while the reference numeral 470 indicates the position of the piezoelectric cantilever 420 after the lock 460 has unlocked. Due to the operation of the piezoelectric effect and the nature of the piezoelectric layer 426 of the piezoelectric cantilever 420, the unlocking of the piezoelectric cantilever 420 and its resulting deformation produce a voltage burst, which is received by the signal conditioning element 442. Various implementations of a sensor 400 as illustrated in FIG. 4A may be tuned to unlock at different external pressure thresholds. A sensor 400 as illustrated in FIG. 4A-4C may be embedded in concrete.

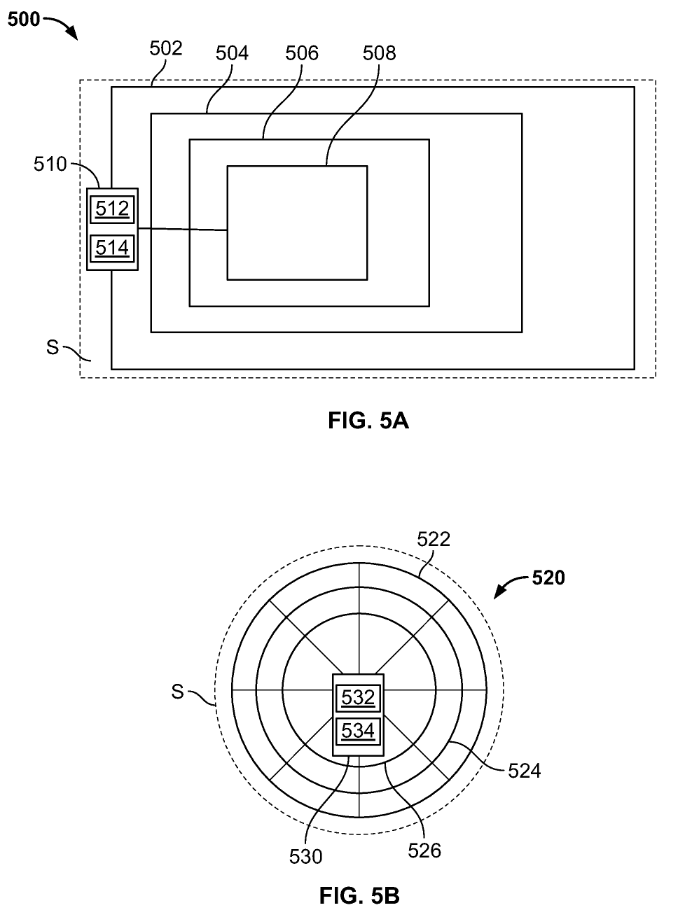

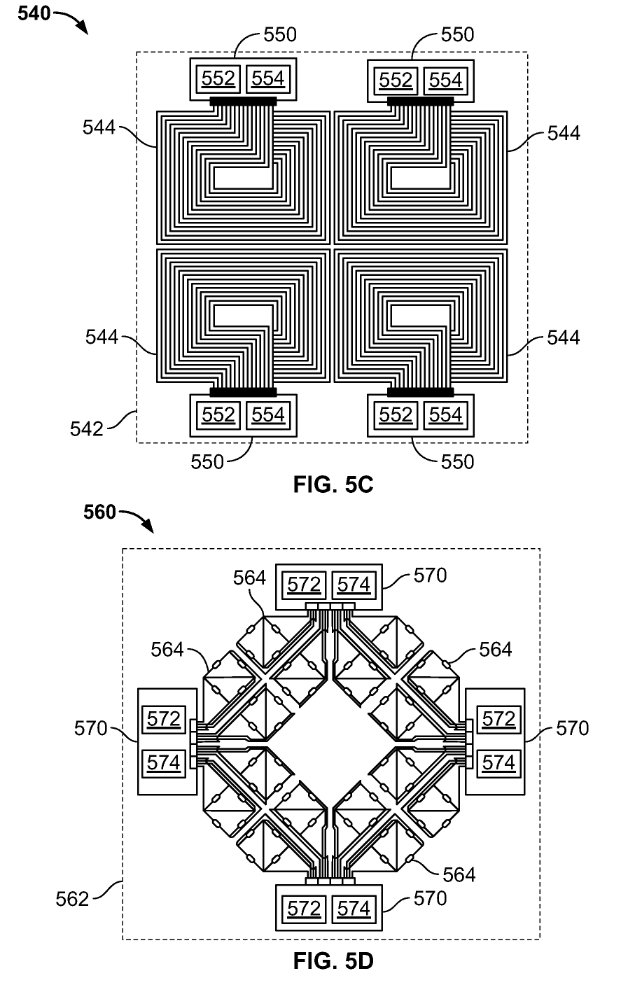

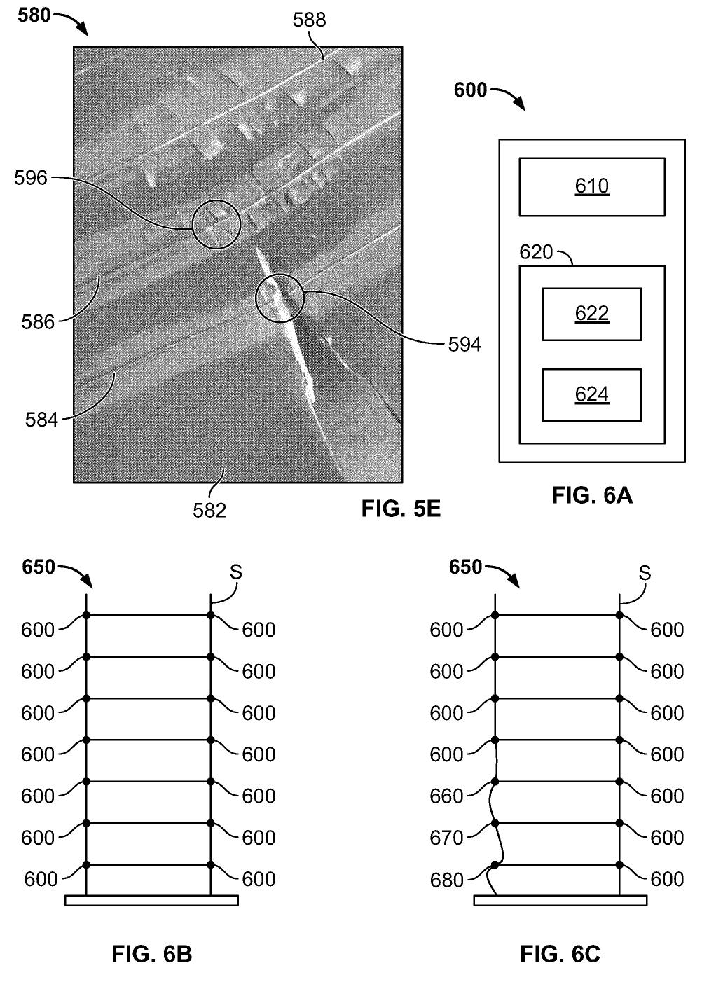

FIGS. 5A, 5B, 5C, and 5D show schematic illustrations of fourth, fifth, sixth, and seventh exemplary embodiments, respectively, of a sensor. The exemplary sensor 500 of FIG. 5A includes a pattern of electrically conductive wires arranged and fixed on a surface S, which has been provided with a dielectric coating. More particularly, the sensor 500 of FIG. 5A includes conductive wires 502, 504, 506, 508 that are arrayed in a configuration including rectangles nested within one another. Each of the wires 502, 504, 506, 508 is electrically coupled to a microchip 510, which includes an integrated signal conditioning element 512 and a passive RFID tag 514. In an embodiment, the signal conditioning element 512 is adapted to determine whether current flows through each of the wires 502, 504, 506, 508 that is coupled to the microchip 510.

The exemplary sensor 520 of FIG. 5B includes a pattern of electrically conductive wires arranged and fixed on a surface S, which has been provided with a dielectric coating. More particularly, the sensor 520 includes conductive wires 522, 524, 526 that are arrayed in a configuration including concentric circles. Each of the wires 522, 524, 526 is electrically coupled to a microchip 530, which includes an integrated signal conditioning element 532 and a passive RFID tag 534. In an embodiment, the signal conditioning element 532 is adapted to determine whether current flows through each of the wires 522, 524, 526 that is coupled to the microchip 530 and the passive RFID tag 534 is adapted to store an on/off measurement based on such determination. The exemplary sensor 540 of FIG. 5C includes a conductive pattern that has been 3D-printed onto a patch 542. The patch 542 may then be bonded to a surface, rather than bonding electrically conductive wires directly to the surface as is the case for the sensors 500 and 520 of FIGS. 5A and 5B. The sensor 540 includes a plurality of sensing patterns 544, each of which includes a plurality of circuits (i.e., conducting elements). Each of the sensing patterns 544 is coupled to a corresponding one of a plurality of microchips 550, each of which includes an integrated signal conditioning element 552 and a passive RFID tag 554. In an embodiment, each signal conditioning element 552 is adapted to determine whether current flows through each of the circuits of the sensing pattern 544 that is coupled to the corresponding microchip 550 and the passive RFID tag 554 is adapted to store an on/off measurement based on such determination.

The exemplary sensor 560 of FIG. 5D includes a conductive pattern that has been 3D-printed onto a patch 562. The patch 562 may then be bonded to a surface, rather than bonding electrically conductive wires directly to the surface as is the case for the sensors 500 and 520 of FIGS. 5A and 5B. The sensor 560 includes a plurality of sensing patterns 564, each of which includes a plurality of conducting elements that are arranged to form a Wheatstone bridge covering the area to be sensed. The conducting elements of each of the sensing patterns 564 are adapted to stretch and narrow in response to mechanical strain; such stretching and narrowing causes a change in electrical resistance. Therefore, when a constant electrical current is applied to one of the sensing patterns 564, the resulting voltage will vary based on the resistance of the sensing element. Therefore, an amount of mechanical strain may be inferred based on a measured voltage. Due to the Wheatstone bridge arrangement of the conducting elements of the sensing patterns 564, very small variations in the resistance of one of the conducting elements, which result from very small amounts of stretching and narrowing, and, ultimately, from very small amounts of strain in the underlying structure, may be detected by the sensor 560. Each of the sensing patterns 564 is coupled to a corresponding one of a plurality of microchips 570, each of which includes an integrated signal conditioning element 572 and a passive RFID tag 574. In an embodiment, each signal conditioning element 572 is adapted to determine a voltage across each of the conducting elements of the sensing pattern 564 that is coupled to the corresponding microchip 570.

The exemplary sensor 500 of FIG. 5A and the exemplary sensor 520 of FIG. 5B include electrically conductive wires arranged and fixed on a surface with a dielectric coating. The exemplary sensor 540 of FIG. 5C and the exemplary sensor 560 of FIG. 5D include conductive patterns that are 3D-printed onto a patch, which may be bonded to a surface rather than bonding electrically conductive wires directly to the surface. In the exemplary sensors 500 and 540 of FIGS. 5A and 5C, respectively, the conductive wire or the 3D-printed conductive pattern is arrayed in a configuration including rectangles nested within one another. In the exemplary sensor 520 of FIG. 5B, the conductive wire or the 3D-printed conductive pattern or is arrayed in a configuration including concentric circles. In the exemplary sensor 560 of FIG. 5D, the 3D-printed conductive pattern is arrayed in a configuration including multiple Wheatstone bridges covering the area to be sensed. In an embodiment, each element of an array of conductive wires or of a 3D-printed conductive pattern is coupled to a microchip including an integrated signal conditioning element and a passive RFID tag.

In an embodiment, any of the exemplary sensors 500, 520, 540, 560 may be attached to a surface that is a metal, composite, concrete, or any other solid surface. As a surface to which such a sensor is attached undergoes straining resulting in damage, the damage is sensed and quantified. As a result of the straining of the surface, individual conductive wires, or conductive patterns consisting of groups of conductive wires, may also strain and eventually break. When the RFID tag of each sensor is interrogated by an RFID reader, electricity is provided to such passive RFID tag (e.g., the passive RFID tag 514 of the sensor 500). The electricity is conveyed to the array of conductive wires (e.g., the wires 502, 504, 506, 508 of the sensor 500) or the 3D-printed conductive pattern (e.g., the conductive patterns 544 of the sensor 540; the conductive patterns 564 of the sensor 560). Straining of such conductive elements causes a change in resistance, which results in a voltage stored in the corresponding passive RFID tag (e.g., the passive RFID tag 514 of the sensor 500). A crack in a conductive element causes a very high resistance, which also results in a voltage to be stored in the corresponding passive RFID tag. In an embodiment, the corresponding signal conditioning element (e.g., the signal conditioning element 532 of the sensor 520) may trigger an on/off switch in the corresponding RFID tag (e.g., the passive RFID tag 534 of the sensor 520), wherein an “on” measurement indicates an intact circuit and an “off” measurement indicates an open circuit. An on/off measurement may be used when large defects (e.g., cracks) are to be sensed. In another embodiment, a signal conditioning element (e.g., the signal conditioning element 572 of the sensor 560) may record a voltage, which may then be stored in a passive RFID tag (e.g., the passive RFID tag 574 of the sensor 560) that is adapted to act as a voltmeter. In such an embodiment, the recorded voltage corresponds directly to the straining of the underlying surface, and, hence, to the level of damage that the surface has sustained.

FIG. 5E shows a photograph of a portion of a damaged sensor 580, which is a prototype of the sensor schematically illustrated in FIG. 5C after undergoing damage. The sensor 580 includes a patch 582 with conductive elements 584, 586, 588 deposited thereon. As a result of applied stress a discrete crack cuts through the surface instrumented by the damaged sensor 580 and through the patch 582. The crack cuts through the conductive element 584 and damages the conductive element 586, while the conductive element 588 remains intact. As a result, the conductive elements 584 and 586 each become part of an open circuit, while the conductive element 588 remains part of a closed circuit. The damage to the conductive elements 584 and 586 is shown in the areas delineated by circles 594 and 596, respectively. Thus, when the sensor 580 is read by an RFID reader, current will not flow through the conductive elements 584 and 586, indicating that the conductive elements 584 and 586 have been damaged. Accordingly, the conditioning element (not shown) of the damaged sensor 580 recognizes the open circuits containing the damaged conducting elements 584 and 586 and indicates an “off” condition for the conducting elements 584 and 586 in the RFID tag (not shown) of the damaged sensor 580, while maintaining an “on” condition for the conducting element 588. As a result, damage to the structure underlying the patch 582 may be inferred.

Continuing to refer to FIGS. 5A and 5B, in another embodiment, piezoelectric film strips may be bonded to a surface in place of electrically conductive wires, and may be arranged as described above (e.g., as nested rectangles or concentric circles). When the film strip is stretched locally due to local straining or deformation of the material, a voltage may be induced in the piezoelectric film strip and a corresponding signal (i.e., voltage) may be sent to the integrated microchip. In such an embodiment, the signal conditioning element of the microchip may be configured to select the maximum voltage received from the connected piezoelectric film strips (which indicates the maximum amount of deformation sustained) and store the maximum voltage in the corresponding passive RFID tag.

In an embodiment, a metal wire, 3D-printed conductive pattern, or piezoelectric film strip network can be interwoven in a composite to register delamination. In an embodiment, a piezoelectric film strip can sense not only failure, but can also sense any strain in the elastic and plastic regime.

In an embodiment, measurements from any of the above-described exemplary sensors may be extracted using an RFID reader. In an embodiment, an RFID reader interrogating a passive RFID tag, such as those in any of the above-described exemplary sensors, may power the tag to transmit digital information to the RFID reader. In an embodiment, a sensor may include multiple thresholds embedded therein, each of which may create a voltage burst of a predefined size corresponding to a predefined strain level. For example, the sensor 100 of FIGS. 1A-1B includes multiple piezoelectric columns 120, 122, 124, 126 corresponding to multiple predefined levels of linear loading, while the sensor 200 of FIGS. 2A-2C includes multiple piezoelectric shells 228 corresponding to multiple predefined levels of pressure. In such an embodiment, a predefined strain level may relate to a corresponding predefined damage status.

In an embodiment, a sensor as described herein may be used for structural health monitoring. A sensor using a passive RFID tag may be embedded on a foil, and may therefore be of small thickness and lightweight. A sensor using a passive RFID tag can be embedded or attached in or on any cross section. The functionality of a sensor using a passive RFID tag that has been attached to a surface and covered by a protective coating, or that has been embedded in material, may be unaffected by the aging of the material. In an embodiment, a combined passive RFID tag containing digital information is updated by a material-inherently triggered signal (e.g., the build-up of pressure, as shown in FIGS. 1B and 2C). The signal is related to a specific material damage state and progression and is sent and saved on the passive RFID tag which gets interrogated by the reader. The reader output is evaluated and alerts about a change in structural integrity. The sensitivity of damage detection can be adjusted.

FIG. 6A shows an eighth embodiment of a sensor 600 that is adapted to detect changes in the incline of a structure that is built out of structural members and connections, and to which the sensor 600 is affixed. The sensor 600 includes an inclinometer 610 coupled to a microchip 620. In an embodiment, the inclinometer 610 is adapted to provide a varying electrical resistance based on its incline (i.e., deflection from a level orientation), such that, when an electrical current is applied thereto, the voltage across the inclinometer 610 will vary based on the incline. In an embodiment, the inclinometer 610 is adapted to provide a plurality of discrete levels of resistance based on a plurality of threshold amounts of incline. For example, the inclinometer 610 may provide a first level of resistance when its orientation is from level to a first threshold incline (e.g., 7 degrees), a second level of resistance when its orientation is from the first threshold incline to a second threshold incline (e.g., 10 degrees), a third level of resistance when its orientation is from a second threshold incline to a third threshold incline (e.g., 20 degrees), and a fourth level of resistance when its orientation is greater than the third threshold incline. The microchip 620 includes an integrated signal conditioning element 622 and a passive RFID tag 624. In an embodiment, when the passive RFID tag 624 is interrogated by an RFID reader, a known electrical current is applied to the inclinometer 610. In an embodiment, the signal conditioning element 622 is adapted to determine a voltage across the inclinometer 610. As described above with reference to the inclinometer 610, the resistance of the inclinometer 610 varies with its incline. Therefore, by determining the voltage across the inclinometer, the incline may be inferred.

FIGS. 6B and 6C show a schematic illustration of a system 650 in which a structure S has been instrumented with multiple instances of the sensor 600. More particularly, FIG. 6B shows the structure S in an undamaged state, while FIG. 6C shows the same structure S in a damaged state. The damaged structure S of FIG. 6C includes damage-indicating sensors 660, 670, and 680. When the sensors 600, 660, 670, 680 are to be read, an RFID reader is operated to interrogate the passive RFID tag 624 of each of the sensors 600, 660, 670, 680. The passive RFID tag 624 of each of the sensors 600, 660, 670, 680 applies a known electrical current to the corresponding inclinometer 610, 660, 670, 680. The inclinometer 610 of each sensor 600, 660, 670, 680 has an electrical resistance that depends on its incline, as described above. Therefore, the voltage measured by each signal conditioning element 622 depends on the incline of the inclinometer 610 of the corresponding sensor 600, 660, 670, 680. This measured voltage is conveyed to the corresponding passive RFID tag 624 and to the RFID reader.

With reference to the specific damaged state represented by FIG. 6C, the extracted data may indicate that the sensor 660 is inclined from its initial orientation by an amount greater than a first threshold incline (e.g., 7 degrees), the sensor 670 is inclined from its initial orientation by an amount greater than a second threshold incline (e.g., ten degrees), and the sensor 680 is inclined from its initial orientation by an amount greater than a third threshold incline (e.g., 20 degrees). The incline of the member may be correlated with damage stages. The measured inclines may indicate that significant yielding has occurred in the portion of the structure S instrumented by the sensor 660, that partial member loss has occurred in the portion of the structure S instrumented by the sensor 670, and that total member failure has occurred in the portion of the structure S instrumented by the sensor 680.

In an embodiment, sensor information can be evaluated with a software application and can be translated into a two-dimensional material-defect-growth mapping of the respective structural components of a structure (e.g., the structure S of FIG. 6C). In an embodiment, the mapping may be visualized on a monitor. In an embodiment, the monitor may show in gray contours the infrastructure (e.g., bridge, aircraft, etc.) to be monitored. In an embodiment, the information read from the RFID tags may provide updated information on defect size, and may be combined with the information from the reader, which may be a mobile device moving in three-dimensional space, and may provide information about x,y,z-coordinates and time. In an embodiment, the sensor information may be used to build a contour-mapping over the contours describing the infrastructure itself. In an embodiment, the sensor information may be used to update the structural integrity at every scan and provide visual alerts about defect growth.

In an embodiment, an embedded passive RFID tag saves digital information which relates to a specific material damage state. In an embodiment, an RFID reader interrogating the tag by powering the tag provides additional information about the location (e.g., in three-dimensional coordinates) and time of scanning. For example, a structure may be instrumented with multiple RFID tags, each of which includes a unique identifier, and analysis software may be preconfigured with location information corresponding to each unique identifier. The information saved on the tag is enabled by a material-inherently triggered signal, and is therefore a direct measurement of the damage state. The signal can be triggered by short-term or long-term damage evolution. A long-term damage evolution process can be monitored by piezoelectric materials which snap through at predefined stress or strain states (e.g., levels of external pressure), which release corresponding voltage bursts. Voltage bursts can be directly related to the material defect stage. Short-term evolving damage can be measured by local material strain through a network of piezoelectric film strips. Alternatively, long-term damage evolution can be sensed through failure of metal wire arrays or 3D-printed conductive patterns on a patch. The arrangement of the metal wires (or, alternatively, 3D-printed pattern) in several arrays (i.e., patterns) allows for identification of damage location, damage size, damage growth rate, and damage type.

Local straining of a piezoelectric film strip may send a signal to the microchip, which may include an integrated signal conditioning element and RFID tag. An RFID reader may interrogate the tag, and receive stored information therefrom. The information from the RFID reader (e.g., information about time, location and damage state) may collected by a software application and visualized in three dimensions. Intact infrastructure (e.g., a bridge, aircraft, or a critical structural component such a train axle) may be shown in a contoured view (e.g., in grey contours), while damage may be highlighted in such a view (e.g., by showing damage in color). Further, a life-cycle approach may be used to link the extent of existing damage and the growth rate of damage to remaining service life, required maintenance programs, and assigned repair costs, providing the engineer or infrastructure owner with a complete set of information about readiness and health of the infrastructure.

The exemplary embodiments describe sensors that may be integrated with a structure to monitor health of the structure. The exemplary sensors may be coupled to a circuit including a signal conditioning element and an RFID tag to accomplish monitoring without the need for wires or an integrated power source. The electric power from an RFID reader may be used to check the integrity of the instrumented structure.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

1. A wireless sensor comprising:
a sensing element adapted to provide an electrical response indicating whether a physical parameter applied to said wireless sensor has exceeded a predetermined threshold;
a signal conditioning element electrically coupled to said sensing element and adapted to detect said electrical response of said sensing element; and
a passive RFID tag electrically coupled to said signal conditioning element, said passive RFID tag being adapted to be powered by an interrogation by an RFID reader, to receive an indication of said electrical response from said signal conditioning element, and to transmit said indication to the RFID reader.

2. The wireless sensor of claim 1, wherein said wireless sensor is adapted to be fixed at a location of a structure in a manner such that said physical parameter applied to said wireless sensor corresponds to a mechanical load applied to the location of the structure.

3. The wireless sensor of claim 1, further comprising a second sensing element adapted to provide a second electrical response indicating whether the physical parameter applied to said wireless sensor has exceeded a second predetermined threshold.

4. The wireless sensor of claim 1, wherein said sensing element includes a piezoelectric element, and wherein said electrical response is a voltage induced in said piezoelectric element by a deformation of said piezoelectric element.

5. The wireless sensor of claim 4, further comprising a hollow spherical body, said hollow spherical body including a wall defining an internal area, said wall having a circular cutout formed therein, wherein said piezoelectric element has a shape of a spherical cap and is sized and shaped so as to be complementary to said circular cutout, and wherein said piezoelectric element is disposed within said circular cutout.

6. The wireless sensor of claim 5, wherein the physical parameter is a pressure, and wherein said piezoelectric element is adapted to deform toward said internal area of said hollow spherical body when the pressure applied to said wireless sensor exceeds said predetermined threshold.

7. The wireless sensor of claim 4, further comprising a hollow spherical body defining an internal surface, a locking element being formed on said internal surface of said spherical body, and a piezoelectric element that is positioned in a first position such that said locking element engages a first end of said piezoelectric element, said piezoelectric element being biased to a second position such that said first end of said piezoelectric element does not engage said locking element.

8. The wireless sensor of claim 7, wherein the physical parameter is a pressure, and wherein said hollow spherical body is sized and shaped so as to deform when the pressure applied to said wireless sensor exceeds said predetermined threshold, whereby said deformation of said hollow spherical body causes said locking element to disengage said first end of said piezoelectric element, thereby allowing said piezoelectric element to move to said second position.

9. The wireless sensor of claim 4, wherein said piezoelectric element has a columnar shape.

10. The wireless sensor of claim 9, wherein the physical parameter is a force, and wherein said columnar piezoelectric element is sized and shaped so as to buckle when the force applied to said wireless sensor exceeds said predetermined threshold.

11. The wireless sensor of claim 4, wherein said piezoelectric element comprises a first dielectric layer, a first metal layer adjacent said first dielectric layer, a piezoelectric layer adjacent said first metal layer and opposite said first dielectric layer, a second metal layer adjacent said piezoelectric layer and opposite said first metal layer, and a second dielectric layer adjacent said second metal layer and opposite said piezoelectric layer.

12. The wireless sensor of claim 1, wherein the physical parameter is a force, wherein said sensing element includes a conducting element that is adapted to crack when the force applied to said wireless sensor exceeds said predetermined threshold, and wherein said electrical response is an indication of whether an applied electrical current flows through said conducting element.

13. The wireless sensor of claim 12, wherein said conducting element is adapted to be bonded directly to an object to be monitored by said wireless sensor.

14. The wireless sensor of claim 12, wherein said conducting element, said signal conditioning element, and said passive RFID tag are disposed on a flexible patch, said flexible patch being adapted to be bonded to an object to be monitored by said wireless sensor.

15. The wireless sensor of claim 1, wherein the physical parameter is a force, wherein said sensing element comprises a conducting element having an electrical resistance, said conducting element being adapted to strain when the force applied to said wireless sensor exceeds said predetermined threshold, said straining of said conducting element changing said electrical resistance of said conducting element, and wherein said electrical response is a voltage across said sensing element when a constant electrical current is applied to said sensing element.

16. The wireless sensor of claim 15, wherein said conducting element, said signal conditioning element, and said passive RFID tag are disposed on a flexible patch, said flexible patch being adapted to be bonded to an object to be monitored by said wireless sensor.

17. The wireless sensor of claim 1, wherein the physical parameter is an incline, and wherein said sensing element comprises an inclinometer element having a varying electrical resistance, said inclinometer element adapted to have a first electrical resistance when the incline is less than said predetermined threshold, said inclinometer adapted to have a second electrical resistance when the incline is greater than said predetermined threshold, said second electrical resistance being different than said first electrical resistance.

18. The wireless sensor of claim 17, wherein said electrical response is a voltage across said inclinometer element when a constant electrical current is applied to said inclinometer element.

19. A method for detecting damage to a structure, comprising the steps of:
affixing a wireless sensor to a location of the structure, said wireless sensor including a sensing element, a signal conditioning element, and a passive radio-frequency identification tag;
operating a radio-frequency identification reader to interrogate said passive radio-frequency identification tag of said wireless sensor, whereby said radio-frequency identification reader powers said passive radio-frequency identification tag; and
receiving, by said radio-frequency identification reader from said passive radio-frequency identification tag of said wireless sensor, a sensing response of said sensing element, said sensing response indicating a damage state at the location of the structure.

20. The method of claim 19, wherein said step of affixing said wireless sensor to the structure includes attaching said wireless sensor to a surface of the structure.

21. The method of claim 19, wherein said step of affixing said sensor to the structure includes embedding said sensor within the structure.
